(19) United States
(12) Patent Application Publication
(10) Pub. No.: US 2015/0254198 A1
(43) Pub. Date: Sep. 10, 2015

(54) METHODS AND APPARATUS RELATED TO BUS ARBITRATION WITHIN A MULTI-MASTER SYSTEM

(71) Applicant: GOOGLE INC., Mountain View, CA (US)

(72) Inventors: Doug Anderson, Mountain View, CA (US); Simon Glass, Mountain View, CA (US); David Hendricks, Campbell, CA (US)

(73) Assignee: GOOGLE INC., Mountain View, CA (US)

(21) Appl. No.: 13/840,390

(22) Filed: Mar. 15, 2013

(51) Int. Cl. G06F 13/364

(52) U.S. Cl. CPC G06F 13/364

(57) ABSTRACT

In one generic aspect, a bus system for bus arbitration is disclosed. The bus system may include a first master device, a second master device, a bus connected to the first master device and the second master device, and a plurality of arbitration lines including a first master claim line associated with the first master device, and a second master claim line associated with the second master device. Each of the first master claim line and the second master claim line may be connected to the first master device and the second master device.

### TECHNICAL FIELD

This description relates to bus arbitration between multiple master devices connected to a shared bus.

### BACKGROUND

Typically, a conventional bus includes two active wires, and a ground connection. The active wires may be referred to as a data line and a clock line. Also, according to some conventional bus systems, multiple masters may share the same bus. For example, more than one integrated chip (IC) can operate as a receiver and/or transmitter, depending on its functionality. An IC that initiates a data transfer on the bus may be considered the bus master, and all other ICs may be regarded as bus slaves.

Bus arbitration may handle the situation of having several masters connected to the same bus. For example, several bus masters can be connected to the same bus and may operate concurrently. In particular, by constantly monitoring the bus for start and stop conditions, the multiple masters can determine whether the bus is currently idle or not. If the bus is busy, a master may delay a pending data transfer until a stop condition indicates that the bus is available again. However, in practice, conventional bus arbitration mechanisms are often difficult and cumbersome to implement in real-world situations.

### SUMMARY

The details of one or more implementations are set forth in the accompanying drawings and the description below. Other features will be apparent from the description and drawings, and from the claims.

In one generic aspect, a bus system for bus arbitration is disclosed. The bus system may include a first master device, a second master device, a bus connected to the first master device and the second master device, and a plurality of arbitration lines including a first master claim line associated with the first master device, and a second master claim line associated with the second master device. Each of the first master claim line and the second master claim line may be connected to the first master device and the second master device.

The bus may include a serial data line and a serial clock line. The first master device may include an application processor, and the second master device may include an embedded controller.

The bus system may further include at least one slave device connected to the bus. The at least one slave device may include at least one of a battery and a power controller. In this example, the application processor may be configured to control charging of the battery.

The first master device may include a first bus interface configured to communicate with the bus, and a first bus arbitration unit configured to output a first claim signal on the first master claim line when the first master device requests access to the bus. The second master device may include a second bus interface configured to communicate with the bus, and a second bus arbitration unit configured to output a second claim signal on the second master claim line when the second master device requests access to the bus.

The first bus arbitration unit configured to output a first claim signal on the first master claim line when the first master device requests access to the bus may include outputting the first claim signal on the first master claim line, waiting a period of time to permit the second master device to detect the first claim signal, detecting whether the second claim signal is on the second master claim line after an expiration of the period of time, and claiming use of the bus if the second claim signal is not detected on the second master claim line.

The detecting whether the second claim signal is on the second master claim line after an expiration of the period of time may include sampling activity on the second master claim line at an instant of time after expiration of the period of time.

The first bus arbitration unit may be configured to release the use of the bus after the first master device has performed a transaction with the bus.

The outputting a first claim signal on the first master claim line when the first master device requests access to the bus may further include determining if a retry time has expired if the second claim signal is detected on the second master claim line, detecting whether the second claim signal is on the second master claim line if the retry time is determined as not expired, and claiming use of the bus if the second claim signal is not detected on the second master claim line.

The outputting a first claim signal on the first master claim line when the first master device requests access to the bus further may include releasing the first claim signal if the retry time is determined as expired and the first master device has not successfully claimed use of the bus.

According to another general aspect, a master device for bus arbitration is disclosed. The master device may include a bus interface configured to communicate with a bus shared with another master device, and a bus arbitration unit, associated with at least one processor, configured to request access to the bus including outputting a first claim signal on a first master claim line connected between the master device and the another master device. Then, the bus arbitration unit may be configured to wait a period of time to permit the another master device to detect the first claim signal, and detect whether a second claim signal is on a second master claim line after an expiration of the period of time. The second master claim line may be connected between the master device and the another master device. The bus arbitration unit may be configured to claim use of the bus if the second claim signal is not detected on the second master claim line.

The bus arbitration unit configured to detect whether a second claim signal is on a second master claim line after an expiration of the period of time may include sampling activity on the second master claim line at an instant of time after expiration of the period of time. The bus arbitration unit may be configured to release the use of the bus after the master device executes a transaction with the bus.

The bus arbitration unit may be configured to determine if a retry time has expired if the second claim signal is detected on the second master claim line, detect whether the second claim signal is on the second master claim line if the retry time is determined as not expired, and claim use of the bus if the second claim signal is not detected on the second master claim line.

The bus arbitration unit may be configured to release the first claim signal if the retry time is determined as expired and the first master device has not successfully claimed use of the bus.

According to another general aspect, a method for bus arbitration is disclosed. The method may include requesting, by at least one processor, access to a bus shared between a master device and another master device including outputting a first claim signal on a first master claim line connected between the master device and the another master device, waiting, by the at least one processor, a period of time to permit the another master device to detect the first claim signal, and detecting, by the at least one processor, whether a second claim signal is on a second master claim line after an expiration of the period of time. The second master claim line may be connected between the master device and the another master device. The method may further include claiming, by the at least one processor, use of the bus if the second claim signal is not detected on the second master claim line.

The detecting, by the at least one processor, whether a second claim signal is on a second master claim line after an expiration of the period of time may include sampling activity on the second master claim line at an instant of time after expiration of the period of time.

The method may include releasing, by the at least one processor, the use of the bus after the master device executes a transaction with the bus.

The method may include determining, by the at least one processor, if a retry time has expired if the second claim signal is detected on the second master claim line, detecting, by the at least one processor, whether the second claim signal is on the second master claim line if the retry time is determined as not expired, and claiming, by the at least one processor, use of the bus if the second claim signal is not detected on the second master claim line.

The method may include releasing, by the at least one processor, the first claim signal if the retry time is determined as expired and the master device has not claimed use of the bus.

### BRIEF DESCRIPTION OF THE DRAWINGS

FIG. 1 illustrates a system for an improved bus arbitration operation using at least a first master device and a second master device;

FIG. 2 illustrates a system for bus arbitration using the first master device, the second master device, and a third master device;

FIG. 3 illustrates a system for bus arbitration with an application processor as the first master device, an embedded controller as the second master device, and a battery and power controller as slave devices;

FIG. 4 illustrates an example of any one of the master devices of FIGS. 1-3;

FIG. 5 illustrates a flowchart depicting example operations of a bus arbitration operation executed by any one of the master devices of FIGS. 1-4; and

FIG. 6 illustrates a flowchart depicting example operations of a bus arbitration operation executed by any one of the master device of FIGS. 1-4 according to another implementation.

### DETAILED DESCRIPTION

This disclosure provides improved bus arbitration for multi-masters on a shared bus. For example, instead of constantly monitoring the bus to determine whether the bus is available, a system is provided that includes a plurality of arbitration lines connected between master devices for managing control of a shared resource such as the shared bus. In one implementation, the plurality of arbitration lines may include at least two General Purpose Input Output (GPIO) lines shared between master devices. The GPIO lines may be considered master claim lines, which are connected between at least two master devices for controlling which master device has access to the shared bus. Each master device may have its own master claim line, where a signal outputted on the master claim line is detectable by the other master device(s) connected to the bus. For instance, when a master device requests use of the shared bus to perform a transaction, the master device may output (e.g., produce, define) a claim signal on its respective master claim line, signaling to the other master device(s) that the master device requests use of the shared bus.

In more detail, each master device may be associated with its own master claim line, which is connected to at least one other master device such that the other master device(s) can detect signals outputted on the master claim line from the master device. In other words, in one example, a first master device and a second master device may share a bus. According to one implementation, the first master device may be associated with a first master claim line, which is connected between the first master device and the second master device. Signals outputted on the first master claim line by the first master device may be detected by the second master device. Also, the second master device may be associated with a second master claim line, which is also connected between the first master device and the second master device. Signals outputted on the second master claim line by the second master device may be detected by the first master device.

If the first master device requires use of the bus, the first master device may output a first claim signal on the first master claim line, signaling to the second master device that the first master device requires use of the bus. If the second master device requires use of the bus, the second master device may output a second claim signal on the second master claim line, signaling to the first master device that the second master device requires use of the bus.

Also, as described herein, the improved bus arbitration may provide a way to efficiently handle multiple bus access requests in the event that more than one master device may require access to the bus. For example, the first master device may include a bus interface configured to communicate with the shared bus, and a bus arbitration unit configured to implement the bus arbitration procedure, as described below. In various implementations, the first master device may request access to the shared bus by outputting the first claim signal on the first master claim line. The first master device may wait a short period of time, and then detect whether the second claim signal is on the second master claim line after an expiration of the period of time. If the second claim signal is not detected on the second master claim line, the bus arbitration unit may claim use of the bus. After the first master device has claimed use of the bus, the first master device can carry out its transaction using the bus. Also, with this bus arbitration procedure, the first master device can carry out its transaction without interference from other master devices which may be requesting use of the bus during the transaction. Further, with this bus arbitration procedure, the master devices are not required to monitor the master claim lines when they are not seeking to claim the bus. These and other features are further explained below with reference to the figures.

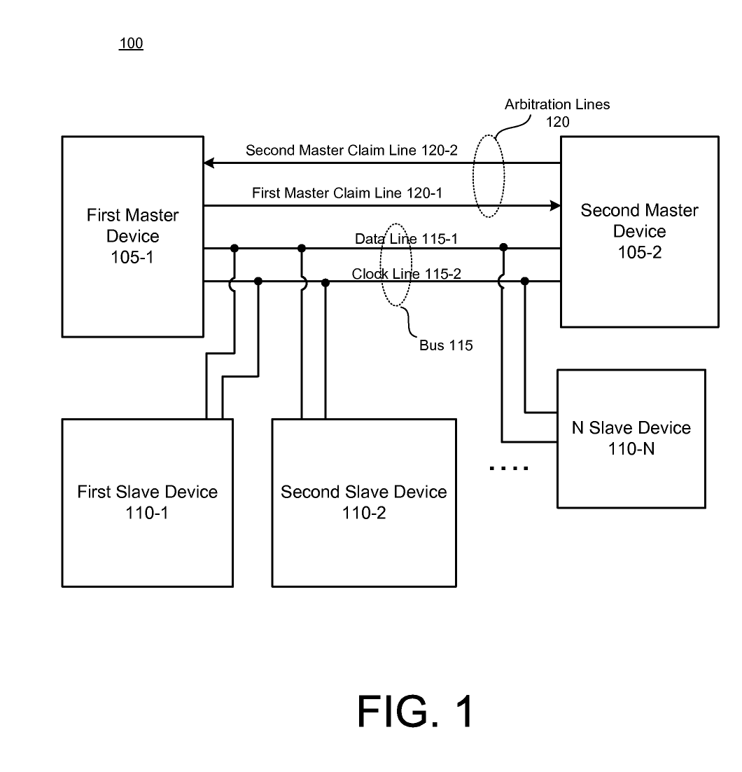

FIG. 1 illustrates a system 100 for bus arbitration using multiple master devices 105. A shown in FIG. 1, the system 100 may include a plurality of master devices 105 (e.g., a first master device 105-1, and a second master device 105-2), a plurality of slave devices 110 (e.g., a first slave device 110-1 to N slave device 110-N), and a bus 115 coupled to the plurality of master devices 105 and the plurality of slave devices 110.

Referring to FIG. 1, the bus 115 may provide a communication link between the master devices 105 and the slave devices 110. As such, the bus 115 may be considered a shared bus because the bus 115 is shared among multiple components. Any one of the master devices 105 connected to the bus 115 may perform a transaction involving any one of the slave devices 110 or another master device 105. Generally, the transaction to be performed by the master devices 105 may include transferring data to and/or from any of the slave devices 110. The details of transferring data among master devices 105 and the slave devices 110 using the bus 115 may widely vary depending on the context of the system 100 and the type of bus 115.

Although only two master devices 105 are illustrated in FIG. 1, the implementations discussed herein may encompass any number of master devices 105 connected to the bus 115. For example, the bus 115 may be configured to support multiple master devices 105. The first master device 105-1 and the second master device 105-2 may be any type of component configured to transfer data, via the bus 115, to a slave device 110 such as any one of the first slave device 110-1 to the N slave device 110-N. In one implementation, each master device 105 may include one or more processors configured to execute transactions with any one of the slave devices 110 using the bus 115. For instance, each master device 105 may include one or more microcontroller and/or digital signal processors (DSP). Also, the type of transactions may depend on the context of the system 100. In one example, the system 100 may be associated with a computing device such as a desktop computer, laptop, smartphone, tablet, eReader, netbook, and/or gaming console. However, the system 100 may be associated with any type of system utilizing the shared bus 115 between multiple master devices 105 and slave devices 110. The type of transactions may be considered too numerous to list to detail, but some generic examples may include reading/writing data to/from the slave devices 110. Further examples are provided within the context of the following disclosure.

Each of the first slave device 110-1 to the N slave device 110-N may be any type of component configured to transfer data to and/or from any one of the master devices 105 using the shared bus 115. The parameter N may be any number greater than or equal to two. In one implementation, the slave devices 110 may include registers, processors, and/or logic components, or generally any type of component connected to the shared bus 115. According to some bus architectures, connected devices that are not requesting access to the bus 115 are considered slave devices. As such, the characterization of a device connected to the bus 115 as either a master or slave may depend on whether the device is requesting access to the bus 115 to perform a transaction. In this respect, the first master device 105-1 and/or the second master device 105-2 may instead be characterized as the slave device 110 depending on the context of the transaction(s).

Generally, the bus 115 may be a communication channel (or link) that is configured to transfer data between components inside a computer or between computers. Referring to FIG. 1, the bus 115 may include a data line 115-1 and a clock line 115-2. However, the bus 115 of FIG. 1 may not be limited to a two-wire bus, where the bus 115 may include any number of components designed to transfer data between components such as a one-wire bus or a bus having more than two wires. The bus 115 may be associated with any type of known bus system such as I²C, serial peripheral interface (SPI), or system management bus (SMBus), for example. More generally, the bus 115 may represent any resource, or the right to access any resource. However, in the implementation of FIG. 1, the data line 115-1 may be bi-directional such that data can be transferred in either direction (e.g., to the slave device 110 or from the slave device 110). Further, the data line 115-1 may be a serial data line or a parallel data line. In more detail, the data line 115-1 may be a communication link by which electronically coded information is transferred to and from the master devices 105 or the slave devices 110.

The clock line 115-2 may be a communication link by which a clock signal is transferred to/from the master device 105 or the slave device 110. For example, typically, the master device 105 generates its own clock signal on the clock line 115-2 to transfer data on the bus 115. Then, the master device 105 or the slave device 110 may transfer the requested data on the data line 115-1 according to the generated clock signal.

According to various implementations, the system 100 may include a plurality of arbitration lines 120 connected between the plurality of master devices 105, as further described below. Also, it is noted that the plurality of arbitration lines 120 are not necessarily connected to (e.g., are independent from, are separate from) the slave devices 110. For instance, the plurality of arbitration lines 120 are used to manage which master device 105 has access to the shared bus 115. When requesting access to the bus 115, the first master device 105-1 or the second master device 105-2 may output a claim signal on its respective master claim line 120, which signals to the other master device 105 that it is requesting access to the bus 115. However, the claim signals outputted on the arbitration lines 120 (also referred to as master claim lines) are not necessarily accessible by the slave devices 110.

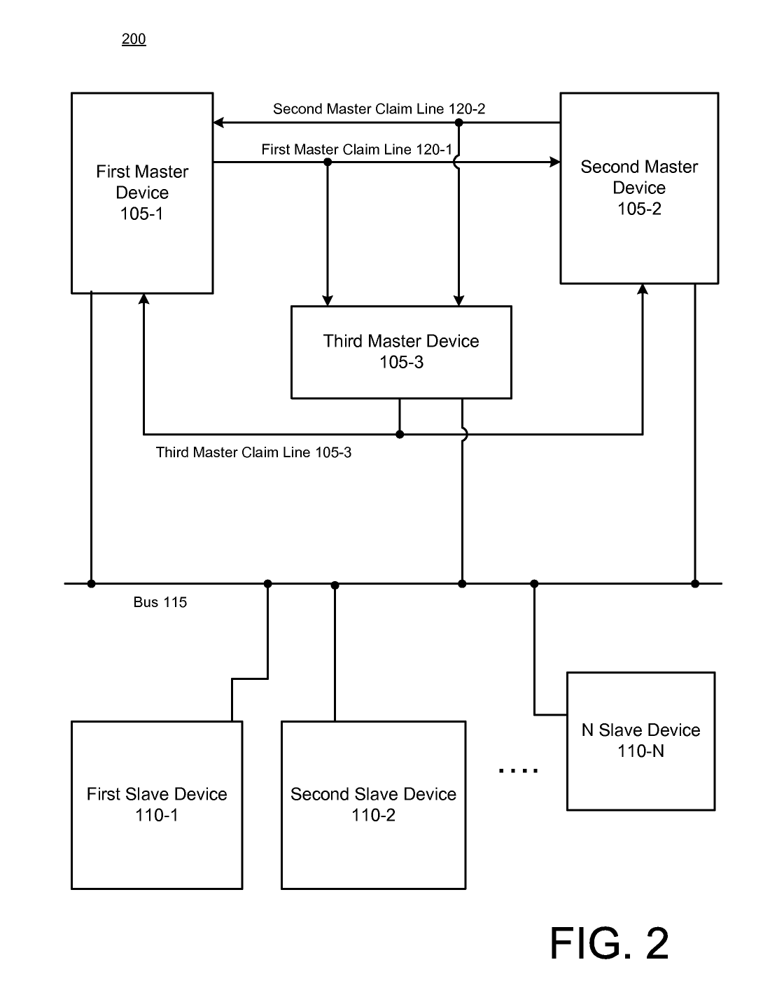

As shown in FIG. 1, the plurality of arbitration lines 120 may include a first master claim line 120-1, and a second master claim line 120-2. However, because each master device 105 is associated with its own master claim line 120, the number of arbitration lines 120 may be dependent on the number of master devices 105. For example, one arbitration line 120 is provided for each master device 105. In one example, as further explained with reference to FIG. 2, if the number of master devices 105 is three, then the number of arbitration lines 120 may be three as well. However, the implementations encompass any number of arbitration lines 120 for use within the system 110, which, again, is dependent on the number of master devices 105. For example, arbitration lines 120 are dedicated on a per-master basis.

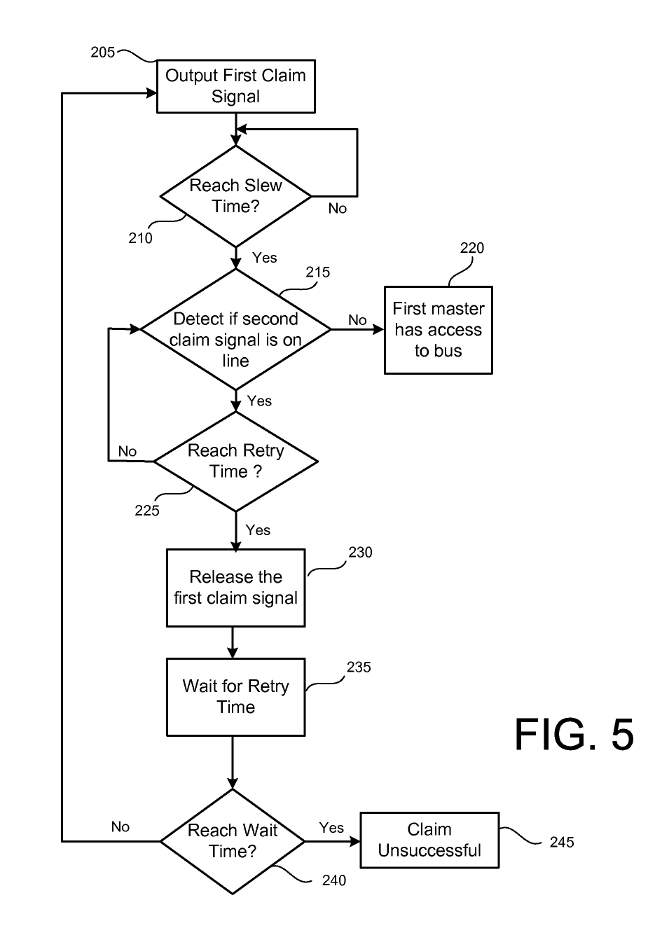

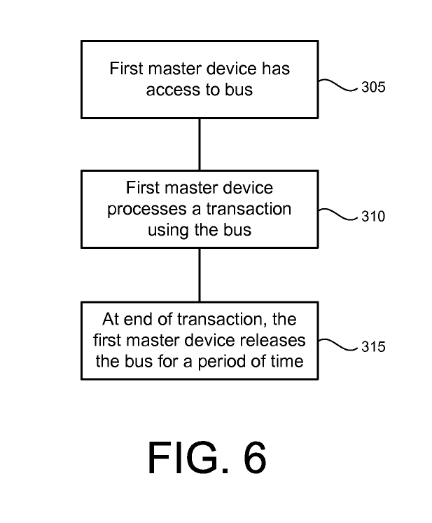

The plurality of arbitration lines 120, separate from the components associated with the bus 115, are used for bus arbitration, e.g., managing use of the shared bus 115. In one implementation, each of the first master claim line 120-1 and the second master claim line 120-2 may include a General Purpose Input Output (GPIO) line shared between the first master device 105-1 and the second master device 105-2. In other words, the plurality of arbitration lines 120 may include at least two General Purpose Input Output (GPIO) lines shared between the master devices 105. The GPIO lines may be considered generic lines (or pins) on the master device 105 whose behavior can be controlled at runtime. Initially, the GPIO lines have no special purposed defined, but, according to the implementations, are configured to implement the bus arbitration operation, as further discussed with reference to FIGS. 5-6 and described herein.

When configured to implement the bus arbitration procedure, the GPIO lines may be referred to as the master claim lines, which are shared between multiple master devices 105 for controlling the use of the shared bus 115. For instance, when a particular master device 105 requests access to the shared bus 115 to perform a transaction, the master device 105 may output a claim signal on its respective master claim line 120, where the claim signal is an output that another master device 105 can detect.

In more detail, each master device 105 may have a master claim line 120, which is connected to at least one other master device 105 such that the other master device(s) 105 can detect signals outputted from the master device 105. In other words, referring to FIG. 1, the first master device 105-1 and the second master device 105-1 may share the bus 115. The first master device 105-1 may be associated with the first master claim line 120-1, which is connected between the first master device 105-1 and the second master device 105-2. For example, after connecting the first master device 105-1 and the second master device 105-2 with the first master claim line 120-1, the first master device 105-1 may be assigned to the first master claim line 120-1 such that a claim signal outputted on the first master claim line 120-1 by the first master device 105-1 may be detected by the second master device 105-2 (e.g., as indicated by the arrow on the first master claim line 120-1).

Also, the second master device 105-2 may be associated with the second master claim line 120-2, which is also connected between the first master device 105-1 and the second master device 105-2. For example, after connecting the first master device 105-1 and the second master device 105-2 with the second master claim line 120-1, the second master device 105-2 may be assigned to the second master claim line 120-2 such that a claim signal outputted on the second master claim line 120-2 by the second master 105-2 may be detected by the first master 105-1 (e.g., as indicated by the arrow on the second master claim line 120-2).

If the first master device 105-1 requires use of the bus 115, the first master device 105-1 may output a first claim signal on the first master claim line 120-1, signaling to the second master device 105-2 that the first master device 105-1 requires use of the bus 115. If the second master device 105-2 requires use of the bus 115, the second master device 105-2 may output a second claim signal on the second master claim line 120-2, signaling to the first master device 105-1 that the second master device 105-2 requires use of the bus. In one example, the first claim signal or the second claim signal having a high voltage level may indicate that the first master device 105-1 or the second master device 105-2 is requesting access to the bus 115. In other words, the first master device 105-1 or the second master device 105-2 may drive its respective master claim line 120 to a high state when requesting use of the bus 115. However, it is noted that the implementations encompass the reverse situation of driving the master claim line 120 to a low state for indicating an access request to the bus 115. In either case, the first claim signal or the second claim signal may indicate an activation state (either high or low) of a corresponding master claim line 120.

FIG. 2 illustrates a system 200 for bus arbitration using three master devices 105. For example, the system 200 is similar to the system 100 of FIG. 1 except for the addition of a third master device 105-3 and a third master claim line 120-3. Therefore, a detailed description of the master devices 105, the bus 115, and the slave devices 110 is omitted for the sake of brevity, and only the differences between the system 200 of FIG. 2 and the system 100 of FIG. 1 will be discussed below.

In the example of FIG. 2, three master devices 105 are connected to the bus 115. As indicated above, each master device 105 may be assigned its own master claim line 120, where a claim signal outputted by a master device 105 on a respective master claim line 120 can be detected by each of the other master devices 105. As such, the first master device 105-1 is assigned to the first master claim line 120-1, the second master device 105-2 is assigned to the second master claim line 120-2, and the third master device 105-3 is assigned to the third master claim line 120-3.

In more detail, the first master device 105-1 is connected to the second master device 105-2 and the third master device 105-3 via the first master claim line 120-1. Therefore, when the first master device 105-1 requires access to the bus 115, the first master device 105-1 may output the first claim signal on the first master claim line 120-1 such that the second master device 120-2 and the third master device 120-3 can detect the first claim signal. Similarly, the second master device 105-2 is connected to the first master device 105-1 and the third master device 105-3 via the second master claim line 120-2. Therefore, when the second master device 105-2 requires access to the bus 115, the second master device 105-2 may output the second claim signal on the second master claim line 120-2 such that the first master device 120-1 and the third master device 120-3 can detect the second claim signal. Also, the third master device 105-3 is connected to the first master device 105-1 and the second master device 105-2 via the third master claim line 120-3. Therefore, when the third master device 105-3 requires access to the bus 115, the third master device 105-3 may output a third claim signal on the third master claim line 120-3 such that the first master device 120-1 and the second master device 120-2 can detect the third claim signal.

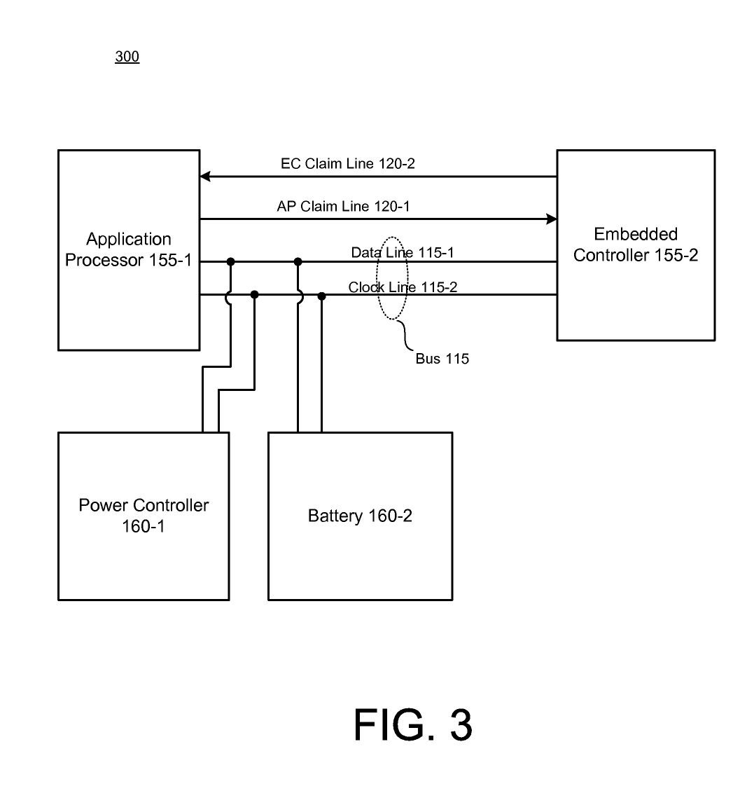

FIG. 3 illustrates a system 300 for bus arbitration with an application processor 155-1 as the first master device 105-1 and an embedded controller 155-2 as the second master device 105-2. For example, the system 300 is similar to the system 100 of FIG. 1 except that the first master device 105-1 is functioning as the application processor 155-1, the second master device 105-2 is functioning as the embedded controller 155-2, the first slave device 110-1 is functioning as a power controller 160-1, and the second slave device 110-2 is functioning as a battery 160-2. The bus 115 including the data line 115-1 and the clock line 115-2 was previously described with reference to FIG. 1, and therefore the details are not duplicated for the sake of brevity.

The application processor 155-1 may be any type of processor designed to support application(s) executing on an operating system of the system 300, which may include the computing device described above. In more detail, the application processor 155-1 may enable various Internet Protocol (IP)-based applications including data, audio, and/or video applications. In one implementation, the application processor 155-1 may be the main computing chip in the system, which is responsible for performing most of the computing operations including handling user interactions. Also, the embedded controller 155-2 may be any type of processor for performing embedded control. For example, functions performed by the embedded controller 155-2 may include battery charging, keyboard scanning, power sequencing, and/or temperature monitoring, as well as other background tasks. However, in this example, the application processor 155-1 may control the battery charging features (e.g., instead of the embedded controller 155-2) and may allow the application processor 155-1 to disable the embedded controller's 155-2 master access to the bus 115 if required.

The power controller 160-1 may control the amount of power provided to the computing device. In particular, the power controller 160-1 may turn off the power, or transition from a normal-power state to a low-power state (e.g., energy saving mode) or vice versa. The battery 160-2 may be a power source providing energy to the circuitry of the computing device. In this implementation, the embedded controller 155-2 and/or the application processor 155-1 may read or write data from/to the power controller 160-1 and/or the battery 160-2 using the shared bus 115. In one implementation, the application processor 155-1 may control the charging of the battery 160-2.

For example, the embedded controller 155-2 cannot execute read/write code until a software synchronization is complete. Therefore, after the application processor 155-1 has transmitted the new/updated software for the software synchronization, the application processor 155-1 may institute a transaction on the bus 115 to control charging of the battery 160-1 before the embedded controller 155-2 executes the read/write code of the new/updated software. As further explained below, the bus arbitration mechanism permits a shared allocation of the bus 115 in a manner that allows the application processor 155-1 to control charging of the battery 160-2.

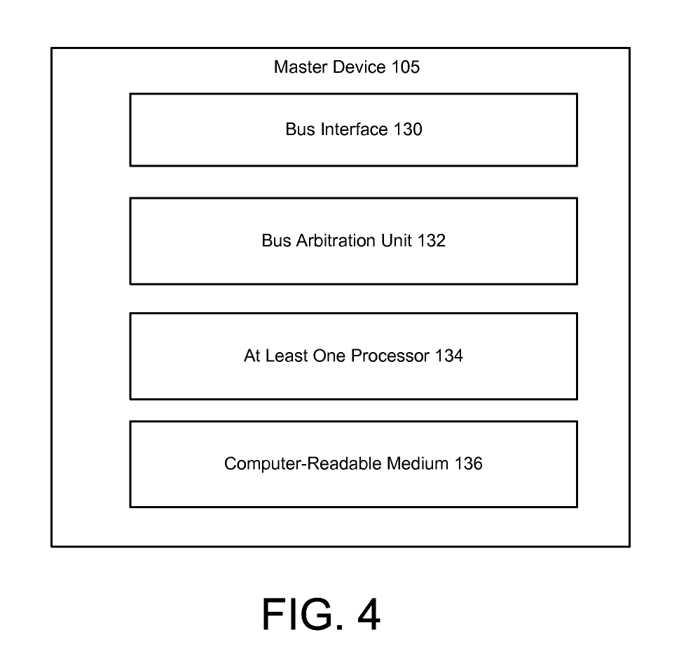

FIG. 4 illustrates an example of any one of the master device 105 of FIGS. 1-3. For example, the master device 105 of FIG. 4 may be the first master device 105-1, the second master device 105-2, or the third master device 105-3 of FIGS. 1 and 2, or generally any master device 105 connected to the bus 115 including the application processor 155-1 or the embedded controller 155-2 of FIG. 3. The master device 105 may include a bus interface 130, a bus arbitration unit 132, at least one processor 134, and a computer-readable medium 136. Also, the master device 105 may include other components depending on the type of master device 105. For example, if the master device 105 includes the application processor 155-1, the master device 105 may include components and functionalities associated with application processors. Similarly, if the master device 105 includes the embedded controller 155-2, the master device 105 may include components and functionalities associated with embedded controllers. However, regardless of the type of master device 105 employed, the master device 105 may include the components of FIG. 4.

The at least one processor 134 may include one or more processors such as microcontrollers or DSPs, and may be configured to implement the functionalities of the master device 105, e.g., the bus arbitration unit 132. The at least one processor 134 may be configured to implement the functionalities of the first master device 105-1, the second master device 105-2, the third master device 105-3, the application processor 155-1 and/or the embedded controller 155-2 depending on the context of the system 100. The computer-readable medium 136 may include any type of storage medium capable of storing instructions/data. For example, the computer-readable medium 136 may include instructions, that when executed by the at least one processor 134 cause the master device 105 (e.g., the bus interface 130, the bus arbitration unit 132, and/or any other component of the master device 105) to perform the functionalities described herein.

The bus interface 130 may be configured to communicate with the shared bus 115. For example, the bus interface 130 may represent an interface that is designed (e.g., configured) to transfer data to and from the shared bus 115, which is eventually targeted for one of the slave devices 110 or another master device 105. The configuration of the bus interface 130 may be dependent on the type of bus system utilized (e.g. I²C, SMBus, etc.), but generally may include ports, pins, modules, or other components designed to connect to the bus 115.

The bus arbitration unit 132 may be configured to execute the bus arbitration mechanism. For example, the bus arbitration unit 132 may be configured to request access to the bus 115 by outputting the claim signal on its respective master claim line 120. In more detail, with respect to the first master device 105-1 and the second master device 105-2 of FIG. 1, the bus arbitration unit 132 of the first master device 105-1 (e.g., a first bus arbitration unit) may output the first claim signal on the first master claim line 120-1 when the first master device 105-1 requires use of the bus 115 to perform a certain transaction. Then, the bus arbitration unit 132 of the first master device 105-1 may wait a period of time to permit the second master device 105-2 to detect the first claim signal. The period of time may be set such that sufficient time exists for the bus arbitration unit 132 of the second master device 105-2 to detect whether the first claim signal is on the first master claim line 120-1. Next, the bus arbitration unit 132 of the first master device 105-1 may detect whether the second claim signal is on the second master claim line 120-2 after an expiration of the period of time.

The bus arbitration unit 132 of the first master device 105-1 may claim use of the bus 115 if the second claim signal is not detected on the second master claim line 120-2. In one example, the bus arbitration unit 132 of the first master device 105-1 may claim use of the bus 115 if identifying an absence (or lack of) the second claim signal on the second master claim line 120-2. It is noted that the bus arbitration unit 132 of the second master device 105-2 (e.g., a second bus arbitration unit) may perform the same steps for accessing the bus 115. Then, the first master device 105-1 may perform its transaction with the bus 115. For example, the first master device 105-1 may transmit a read/write command to the corresponding slave device 110 on the shared bus 115 via the bus interface 130 (e.g., a first bus interface). Also, because the second master device 105-2 performs the same operations for claiming use of the bus 115, the transaction executed by the first master device 105-1 is not interrupted when the second master device 105-2 requires use of the bus 115 during the execution of the transaction. The functionalities of the bus arbitration unit 132 may be easily extended to the system 200 of FIG. 2 involving three master devices 105 or the system 300 of FIG. 3 involving the application processor 155-1 and the embedded controller 155-2. These and other features of the bus arbitration unit 132 are further discussed with reference to FIGS. 5-6.

FIG. 5 illustrates a flowchart depicting example operations for the bus arbitration procedure executed by any one of the master devices 105 of FIGS. 1-4. Although the flowchart of FIG. 5 illustrates the operations in sequential order, this is merely an example, and additional or alternative operations may be included. Further, the example operations of FIG. 5 and related operations may be executed in a different order than that shown, or in a parallel or overlapping fashion. The example operations of FIG. 5 are from the perspective of the first master device 105-1. However, it is noted that these operations may be performed by any one of the master devices 105 including the second master device 105-2, the third master device 105-3, the application processor 155-1, or the embedded controller 155-2.

A first claim signal may be outputted (205). For example, the bus arbitration unit 132 may be configured to request access to the bus 115 for eventually performing a transaction using the bus 115 in conjunction with one or more slave devices 110. In particular, in order to request access to the bus 115, the bus arbitration unit 132 may be configured to output a claim signal on its respective master claim line 120. From the point of view of the first master device 105-1, the bus arbitration unit 132 may output the first claim signal on the first master claim line 120-1, signaling to the second master device 105-2 that the first master device 105-1 requires use of the bus 115. As indicated above, in one implementation, the bus arbitration unit 132 may be configured to drive the first master claim line 120-1 to an activation state (e.g., either a high state or low state), which signals to the other master devices 105 that the first master device 105-1 requires the bus 115 for a currently pending transaction.

A period of time may be determined as reached (210). For example, the bus arbitration unit 132 of the first master device 105-1 may be configured to wait a period of time to permit at least one other master device 105 (e.g., the second master device 105-2) to detect the first claim signal on the first master claim line 120-1. The period of time may be set such that sufficient time exists for the bus arbitration unit 132 of the second master device 105-2 to detect whether the first claim signal is on the first master claim line 120-1. In one example, this period of time may be considered a slew time. In one implementation, the period of time may be set up to 10 microseconds. However, this time parameter may encompass any time value, which may be dependent on the type of system 100 employed. In one implementation, the second master device 105-2 may detect whether the first claim signal is on the first master claim line 120-1 (e.g., whether first master claim line 120-1 is activated) by monitoring the state of the first master claim line 120-1.

A second claim signal may be detected on a second master claim line (215). For example, the bus arbitration unit 132 of the first master device 105-1 may detect whether the second claim signal is on the second master claim line 120-2. For example, the bus arbitration unit 132 of the first master device 105-1 may determine whether the second master device 105-2 is currently requesting use of the bus 115, e.g., whether the second master device 105-2 has an outstanding claim to the bus 115. For instance, as indicated above, when the second master device 105-2 requires use of the bus 115 to perform a pending transaction using the bus 115, the second master device 105-2 may output the second claim signal on the second master claim line 120-2. Accordingly, in the context of the first master device 105-1 checking to determine if the second master device 105-2 has an outstanding access request for the bus 115, the bus arbitration unit 132 of the first master device 105-1 may detect whether the second claim signal, outputted by the bus arbitration unit 132 of the second master device 105-2, is on the second master claim line 120-2.

In one implementation, the bus arbitration unit 132 of the first master device 105-1 can configured to detect whether the second claim signal is on the second master claim line 120-2 by sampling activity on the second master claim line 120-2 at an instant of time after the expiration of the period time. For example, instead of constantly monitoring the second master claim line 120-2 (which requires more computing processing resources), the bus arbitration unit 132 of the first master device 105-1 may sample the activity on the second master claim line 120-2 after the expiration of the period time. In various implementations, the bus arbitration unit 132 of the first master device 105-1 may sample the activity on the second master claim line 120-2 immediately after the expiration of the period time In one implementation, the sampling may include detecting whether the second master claim line 120-2 is in a high or low state. If it is detected that the second master claim line 120-2 is in the high state (or alternatively the low state), the bus arbitration unit 132 of the first master device 105-1 may determine that the second master device 105-2 is claiming use of the bus 115 and/or has access to the bus 115.

If the second claim signal is not detected on the second master claim line, the first master device has access to the bus (220). For example, the bus arbitration unit 132 of the first master device 105-1 may claim use of the bus 115 if the second claim signal is not detected on the second master claim line 120-2. For instance, the bus arbitration unit 132 of the first master device 105-1 may detect an absence of the second claim signal on the second master claim line 120-2, e.g., detecting that the second master claim line 120-2 is in a non-activation state (either a high-state or a low-state). After the bus arbitration unit 132 has claimed access to the bus 115, the first master device 105-1 may perform its transaction with any one of the slave devices 110 using the bus 115. In some implementations, the bus arbitration unit 132 of the first master device 105-1 may continue to drive the first master claim line 120-2 in the high state until the completion of the corresponding transaction, which signals to the second master device 105-2 that the bus 115 is currently being utilized.

According to another implementation, regardless if the first master device 105-1 has another pending transaction to process with the bus 115, the bus arbitration unit 132 of the first master device 105-1 may be configured to release its claim to the bus 115 after the first master device 105-1 has performed the first transaction with the bus 115. For example, the bus arbitration unit 132 of the first master device 105-1 may drive the first master claim line 120-1 to the low state (or alternatively the high state) after completing its corresponding transaction. This will allow an opportunity for the second master device 105-2 to claim the bus 115, and avoid a situation where one master device 105 always has control of the bus 115. This feature is further explained with reference to FIG. 6.

If the second claim signal is detected on the second master claim line, a retry time may be determined as reached (225). For example, if the second claim signal is detected on the second master claim line 120-2, the bus arbitration unit 132 of the first master device 105-1 may determine if a retry time has been reached. In one implementation, the retry time may be configured to be greater than the longest expected signal transaction using the bus 115. In one example, the longest expected single transaction for an I²C bus may be approximately 20 bytes, which at 60 KHz, is 2.6 ms. As such, in one implementation, the retry time may be set to any value greater than 2.6 ms such as 3 ms, for example. However, the retry time is an adjustable parameter, and may be set at any time value such as twice the longest expected transaction, for example. If the bus arbitration unit 132 of the first master device 105-1 has determined that the retry time has not been reached, the process returns to step 215 to determine if the second claim signal is on the second master claim line 120-2 as discussed above. For instance, before the retry time is reached, the bus arbitration unit 132 may repeatedly sample activity on the second master claim line 120-2 in order to determine if the second master device 105-2 has an outstanding claim.

When the retry time is reached, the first claim signal may be released (230). For example, the bus arbitration unit 132 of the first master device 105-1 may release the first claim signal when the retry time has expired and the first master device 105-1 has not claimed access to the shared bus 115. In particular, the bus arbitration unit 132 may de-activate the first master claim line 120-1 when the retry time has expired and the first master device 105-1 has not claimed access to the shared bus 115.

Then, a retry time may be waited (235). For example, the bus arbitration unit 132 may wait for an expiration of another retry time. This additional retry time may be the same time value as the retry time of step 225, or may be a different time value.

A wait time may be determined as reached (240). For example, upon expiration of the second retry time (235), the bus arbitration unit 132 of the first master device 105-1 may determine whether a wait time period has expired. If it is determined that the wait time has not expired, the process returns to step 205, where the first claim signal is re-outputted on the first master claim line 120-1. However, if the wait time is determined as expired, the bus arbitration unit 132 of the first master device 105-1 may determine its bus claim as unsuccessful (245).

In one implementation, the wait time may be determined based on the maximum time permitted for a bus request. In one particular example, the wait time may be set up to 50 ms. For instance, after 7-9 retry cycles (which is approximately 50 ms), it may be assumed that the first master device's claim will not be allowed (245). However, the wait time is a configurable parameter and may be extended depending the load of the system 100. For instance, the load of the system 100 may affect how long the wait time is set. For relatively heavy loads, the wait time may be extended. In contrast, for relatively smaller loads, the wait time may be reduced. In one example, the wait time may be up to 200 ms to handle relatively heavy loads.

FIG. 6 illustrates a flowchart depicting example operations for the bus arbitration procedure executed by any of the master devices 105 of FIGS. 1-4 according to another implementation. Although the flowchart of FIG. 6 illustrates the operations in sequential order, it will be appreciated that this is merely an example, and that additional or alternative operations may be included. Further, the example operations of FIG. 6 and related operations may be executed in a different order than that shown, or in a parallel or overlapping fashion. The example operations of FIG. 6 are from the perspective of the first master device 105-1. However, it is noted that these operations may be performed by any of the master devices 105 of FIGS. 1-4.

A first master device has access to the bus (305). For example, using the arbitration operations of FIG. 5, it is assumed that the first master device 105-1 has claimed access to the bus 115 to perform a transaction. Then, the first master device may process the transaction using the bus (310). For example, the first master device 105-1 may process the transaction using the bus 115, which may depend on the type of bus system utilized.

At the end of the transaction, the first master device may release the bus for at least a period of time (315). For example, regardless if the first master device 105-1 has another pending transaction to process with the bus 115, the bus arbitration unit 132 of the first master device 105-1 may be configured to release the bus 115 after the first master device 105-1 has performed a transaction with the bus 115. In other words, anytime the first master device 15-1 has performed a transaction with the bus 115, the first master device 105-1 is configured to release its claim to the bus 115. This will allow an opportunity for the second master device 105-2 to use the bus 115, and avoid a situation where one master device 105 always has control of the bus 115. In one implementation, the bus arbitration unit 132 may drive the first master claim line 120-1 to a low state (or alternatively the high state), indicating to the other master devices 105 that the first master device 105-1 has released its claim to the bus 115.

In another example, the first master device 105-1 has claimed use of the bus 115 and requires use of the bus 115 for a significant period in order to perform a series of pending transactions. Then, the second master device 105-2 asserts a claim to the bus 115 (e.g. outputs a second claim signal on the second master claim line 120-2). At the end of any of the first master device's pending transactions, the first master device 105-1 is required to release the bus 115 for at least a period of time. In one implementation, this period of time may be set to allow sufficient time to allow another master device 105-1 to claim use of the bus 115. In a further example, this period of time may be up to 10 μs, however, may include any time value. After the first master device 105-1 has released the bus 115, in the context of this example, the second master device 105-2 still has its claim asserted. The first master device 105-1 must wait to re-claim use of the bus 115. As a result, the requirement of releasing the bus 115 after the performance of any transaction may ensure fair use of the bus 115 such that one master device 105 does not receive most (or all) the bandwidth.

The code provided below reflects the arbitration operations of FIGS. 5 and 6 from the perspective of the master device 105 as the embedded controller 155-2. However, this open source GPL code may be similar for other types of master devices 105.

```
int board_i2c_claim(int port)
{
  timestamp_t start;
  /* Start a round of trying to claim the bus */
  start = get_time( );
  do {
    timestamp_t start_retry;
    /* Indicate that we want to claim the bus */
    gpio_set_level(GPIO_EC_CLAIM, 0);
    usleep(BUS_SLEW_DELAY_US);
    /* Wait for the AP to release it */
    start_retry = get_time( );
    while (time_since32(start_retry) < BUS_WAIT_RETRY_US) {
      if (gpio_get_level(GPIO_AP_CLAIM)) {
        /* We got it, so return */
        return EC_SUCCESS;
      }
    }
    /* It didn't release, so give up, wait, and try again */
    gpio_set_level(GPIO_EC_CLAIM, 1);
    usleep(BUS_WAIT_RETRY_US);
  } while (time_since32(start) < BUS_WAIT_FREE_US);
  gpio_set_level(GPIO_EC_CLAIM, 1);
  usleep(BUS_SLEW_DELAY_US);
  panic_puts(″Unable to access 12C bus (arbitration timeout)\n″);
  return EC_ERROR_BUSY;
  }
void board_i2c_release(int port)
{
  /* Release our claim */
  gpio_set_level(GPIO_EC_CLAIM, 1);
  usleep(BUS_SLEW_DELAY_US);
}
```

In the context of the first master device 105-1 including the application processor 155-1, and the second master device 105-2 including the embedded controller 155-2, within a computing device (e.g., computer, laptop, smartphone, etc.), the application processor 155-1 will normally have most of the access to the bus 115. If one master device 105 requires use of the bus 115 (e.g., the application processor 155-1) while the another master device 105 does not (e.g., the embedded controller 155-2), the overhead may be considered only the slew time, measured in microseconds, which may be less than a single bit time on an I²C-implemented bus 115. As indicated above, the retry time may be set longer than the maximum transaction length so that even if one master device 105 requires use of the bus 115 just after the other master device 105 has started its longest transaction, the system 100 may still operate efficiently. Otherwise, if both master devices 105 require access to the bus 115, the overhead may be a few milliseconds, for example.

This configuration may permit the application processor 155-1 to control the charging of the battery 160-2, which may be considered one of the slave devices 110. For example, the embedded controller 155-2 cannot execute read/write code until the software synchronization is complete. Therefore, after the application processor 155-1 has transmitted the new/updated software for the software synchronization, the application processor 155-1 may institute a transaction on the bus 115 to control charging of the battery 160-2 before the embedded controller 155-2 executes the read/write code of the new/updated software to ensure that the embedded controller 155-2 has sufficient power to perform its transaction.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (e.g., a non-transitory computer-readable medium such the computer-readable medium 136), for processing by, or to control the operation of, data processing apparatus, e.g., a programmable processor, a computer, or multiple computers (e.g., the master devices 105). Thus, a computer-readable storage medium can be configured to store instructions that when executed cause a processor (e.g., the at least one processor 134) to perform a process. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory, a random access memory, and/or read/write memory. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), a light emitting diode (LED), or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Reference throughout this specification to “one implementation”, or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.”

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A bus system for bus arbitration, the bus system comprising:
a first master device;
a second master device;
a bus connected to the first master device and the second master device; and
a plurality of arbitration lines including a first master claim line associated with the first master device, and a second master claim line associated with the second master device, each of the first master claim line and the second master claim line being connected to the first master device and the second master device.

2. The bus system of claim 1, wherein the bus includes a serial data line and a serial clock line.

3. The bus system of claim 1, wherein the first master device includes an application processor, and the second master device includes an embedded controller.

4. The bus system of claim 3, further comprising:
at least one slave device connected to the bus, the at least one slave device including at least one of a battery and a power controller, wherein the application processor is configured to control charging of the battery.

5. The bus system of claim 1, wherein:
the first master device includes a first bus interface configured to communicate with the bus, and a first bus arbitration unit configured to output a first claim signal on the first master claim line when the first master device requests access to the bus,
the second master device includes a second bus interface configured to communicate with the bus, and a second bus arbitration unit configured to output a second claim signal on the second master claim line when the second master device requests access to the bus.

6. The bus system of claim 5, wherein the first bus arbitration unit configured to output a first claim signal on the first master claim line when the first master device requests access to the bus includes:
outputting the first claim signal on the first master claim line;
waiting a period of time to permit the second master device to detect the first claim signal;
detecting whether the second claim signal is on the second master claim line after an expiration of the period of time; and
claiming use of the bus if the second claim signal is not detected on the second master claim line.

7. The bus system of claim 6, wherein the detecting whether the second claim signal is on the second master claim line after an expiration of the period of time includes sampling activity on the second master claim line at an instant of time after expiration of the period of time.

8. The bus system of claim 6, wherein the first bus arbitration unit is configured to release the use of the bus after the first master device has performed a transaction with the bus.

9. The bus system of claim 6, wherein the outputting a first claim signal on the first master claim line when the first master device requests access to the bus further includes:
determining if a retry time has expired if the second claim signal is detected on the second master claim line;
detecting whether the second claim signal is on the second master claim line if the retry time is determined as not expired; and
claiming use of the bus if the second claim signal is not detected on the second master claim line.

10. The bus system of claim 9, wherein the outputting a first claim signal on the first master claim line when the first master device requests access to the bus further includes:
releasing the first claim signal if the retry time is determined as expired and the first master device has not successfully claimed use of the bus.

11. A master device for bus arbitration, the master device comprising:
a bus interface configured to communicate with a bus shared with another master device; and
a bus arbitration unit, associated with at least one processor, configured to request access to the bus including outputting a first claim signal on a first master claim line connected between the master device and the another master device,
the bus arbitration unit configured to wait a period of time to permit the another master device to detect the first claim signal,
the bus arbitration unit configured to detect whether a second claim signal is on a second master claim line after an expiration of the period of time, the second master claim line being connected between the master device and the another master device, and
the bus arbitration unit configured to claim use of the bus if the second claim signal is not detected on the second master claim line.

12. The master device of claim 11, wherein the bus arbitration unit configured to detect whether a second claim signal is on a second master claim line after an expiration of the period of time includes sampling activity on the second master claim line at an instant of time after expiration of the period of time.

13. The master device of claim 11, wherein the bus arbitration unit is configured to release the use of the bus after the master device executes a transaction with the bus.

14. The master device of claim 11, further comprising:
the bus arbitration unit configured to determine if a retry time has expired if the second claim signal is detected on the second master claim line,
the bus arbitration unit configured to detect whether the second claim signal is on the second master claim line if the retry time is determined as not expired, and
the bus arbitration unit configured to claim use of the bus if the second claim signal is not detected on the second master claim line.

15. The master device of claim 14, further comprising:
the bus arbitration unit configured to release the first claim signal if the retry time is determined as expired and the first master device has not successfully claimed use of the bus.

16. A method for bus arbitration, the method comprising:
requesting, by at least one processor, access to a bus shared between a master device and another master device including outputting a first claim signal on a first master claim line connected between the master device and the another master device;
waiting, by the at least one processor, a period of time to permit the another master device to detect the first claim signal;
detecting, by the at least one processor, whether a second claim signal is on a second master claim line after an expiration of the period of time, the second master claim line being connected between the master device and the another master device; and
claiming, by the at least one processor, use of the bus if the second claim signal is not detected on the second master claim line.

17. The method of claim 16, wherein the detecting, by the at least one processor, whether a second claim signal is on a second master claim line after an expiration of the period of time includes sampling activity on the second master claim line at an instant of time after expiration of the period of time.

18. The method of claim 16, further comprising:
releasing, by the at least one processor, the use of the bus after the master device executes a transaction with the bus.

19. The method of claim 16, further comprising:
determining, by the at least one processor, if a retry time has expired if the second claim signal is detected on the second master claim line;
detecting, by the at least one processor, whether the second claim signal is on the second master claim line if the retry time is determined as not expired; and
claiming, by the at least one processor, use of the bus if the second claim signal is not detected on the second master claim line.

20. The method of claim 19, further comprising:
releasing, by the at least one processor, the first claim signal if the retry time is determined as expired and the master device has not claimed use of the bus.
